(19) United States
(12) Patent Application Publication
(10) Pub. No.: US 2025/0247861 A1
(43) Pub. Date: Jul. 31, 2025

(54) DETERMINING A BEST BEAM FROM RECEIVED FEEDBACK

(71) Applicant: Lenovo (Singapore) Pte. Ltd., Singapore (SG)

(72) Inventors: Karthikeyan Ganesan, Kronberg im Taunus (DE); Vijay Nangia, Woodridge, IL (US); Joachim Löhr, Wiesbaden (DE); Prateek Basu Mallick, Dreieich (DE); Ravi Kuchibhotla, Chicago, IL (US)

(21) Appl. No.: 18/856,025

(22) PCT Filed: Apr. 11, 2023
(86) PCT No.: PCT/IB2023/053712

§ 371 Date: Oct. 10, 2024

Related U.S. Application Data
(60) Provisional application No. 63/329,834, filed on Apr. 11, 2022.

(51) Int. Cl. H04W 72/25; H04B 7/06

(52) U.S. Cl. CPC H04W 72/25; H04B 7/0626; H04B 7/06954; H04B 7/06968

(57) ABSTRACT

Apparatuses, methods, and systems are disclosed for determining a best beam for SL communication. One method (800) at a transmitting entity includes configuring (805) a SL RS for beam establishment transmission and performing (810) a plurality of transmissions of the SL RS, where each of the plurality of transmissions is associated with a different spatial direction, and where each of the plurality of transmissions is performed using one of a plurality of transmit beams. The method (800 includes) receiving (815) a feedback transmission from a Rx UE, where the feedback transmission indicates support of beam correspondence at the Rx UE, and determining (820) a best transmit beam of the plurality of transmit beams based on the received feedback transmission.

### CROSS-REFERENCE TO RELATED APPLICATIONS

This application claims priority to U.S. Provisional Patent Application No. 63/329,834 entitled “BEAM ESTABLISHMENT PROCEDURE FOR UNICAST TRANSMISSION” and filed on 11 Apr. 2022 for Karthik Ganesan, Vijay Nangia, Joachim Löhr, Prateek Basu Mallick, and Ravi Kuchibhotla, which application is incorporated herein by reference.

### FIELD

The subject matter disclosed herein relates generally to wireless communications and more particularly relates to determining a beast beam from received feedback, e.g., in beam establishment procedures for unicast transmission among sidelink (“SL”) devices.

### BACKGROUND

A wireless communications system may include one or multiple network communication devices, such as base stations, which may be otherwise known as an evolved NodeB (“eNB”), a next-generation NodeB (“gNB”), or other suitable terminology. Each network communication devices, such as a base station may support wireless communications for one or multiple user communication devices, which may be otherwise known as user equipment (“UE”), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers). Additionally, the wireless communications system may support wireless communications across various radio access technologies including third generation (“3G”) Radio Access Technology (“RAT”), fourth generation (“4G”) RAT, fifth generation (“5G”) RAT, among other suitable RATs beyond 5G (e.g., sixth generation (“6G”)).

SL communication refers to peer-to-peer communication directly between User Equipment (“UE”) devices. Accordingly, the UEs communicate with one another without the communications being relayed via the mobile network (i.e., without the need of a base station).

### BRIEF SUMMARY

The present disclosure relates to methods, apparatuses, and systems that support techniques for determining a beast beam from received feedback, e.g., for beam establishment between a transmitter UE (“Tx UE”) and a receiver UE (“Rx UE”). Said techniques may be implemented by apparatus, systems, methods, or computer program products.

One method at a transmitting device, such as a Tx UE, includes configuring a sidelink reference signal (“SL RS”) for beam establishment transmission and performing a plurality of transmissions of the SL RS, where each of the plurality of transmissions is associated with different spatial directions, and where each of the plurality of transmissions is performed using one of a plurality of transmit beams. The method includes receiving a feedback transmission from a Rx UE, where the feedback transmission indicates support of beam correspondence at the Rx UE, and determining a best transmit beam of the plurality of transmit beams based on the received feedback transmission.

One method at a receiving device, such as an Rx UE, includes receiving a plurality of transmissions of a SL RS, where each of the plurality of transmissions is associated with a different spatial direction, and where each of the plurality of transmissions is received using one of a plurality of beams. The method includes determining, based on the received plurality of transmissions, a best receive beam for SL reception and transmitting feedback information to a Tx UE, where the feedback information indicates the best receive beam and indicates support of beam correspondence at the receiving UE device.

### BRIEF DESCRIPTION OF THE DRAWINGS

FIG. 1 illustrates an example of a wireless communication system that supports techniques for determining a best beam for SL communication, in accordance with aspects of the present disclosure;

FIG. 2 illustrates an example of a Third Generation Partnership Project (“3GPP”) New Radio (“NR”) protocol stack that supports different protocol layers in the UE and network, in accordance with aspects of the present disclosure:

FIG. 3 illustrates an example of a 3GPP SL protocol stack that supports different protocol layers in the Tx UE and Rx UE, in accordance with aspects of the present disclosure:

FIG. 4 illustrates an example of a procedure for beam establishment procedure for unicast transmission, in accordance with aspects of the present disclosure:

FIG. 5 illustrates an example of a Layer-2 link establishment procedure, in accordance with aspects of the present disclosure:

FIG. 6 illustrates an example of a UE apparatus that supports techniques for determining a best beam for SL communication, in accordance with aspects of the present disclosure:

FIG. 7 illustrates an example of a network equipment (“NE”) apparatus that supports techniques for determining a best beam for SL communication, in accordance with aspects of the present disclosure:

FIG. 8 illustrates a flowchart of one method that supports techniques for determining a best beam for SL communication, in accordance with aspects of the present disclosure; and

FIG. 9 illustrates a flowchart of another method that supports techniques for determining a best beam for SL communication, in accordance with aspects of the present disclosure.

### DETAILED DESCRIPTION

The present disclosure describes systems, methods, and apparatus that support techniques for beam establishment between a Tx UE and Rx UE. In certain embodiments, the methods may be performed using computer code embedded on a computer-readable medium. In certain embodiments, an apparatus or system may include a computer-readable medium containing computer-readable code which, when executed by a processor, causes the apparatus or system to perform at least a portion of the below described solutions.

In 3GPP, NR-Uu Release 15 standardized Synchronization Signal Block to Random-Access Channel (“SSB-RACH”) correspondence mechanism for initial beam alignment. However, in NR-PC5 such complex mechanism is not needed because not all UEs transmit Sidelink Synchronization Signal Block (“SL-SSB”). In Vehicle-to-Everything (“V2X”), the Sidelink Synchronization Signal (“SLSS”) is only transmitted by the synchronization reference (“SyncRef”) UE to provide sync source to all nearby UEs (so not all UEs transmit SLSS). Unicast session can also be established with UEs that are not transmitting SLSS.

Due to lack of spectrum in Frequency Range #1 (“FR1”) (i.e., frequencies from 410 MHz to 7125 MHz) for SL deployment, SL for Frequency Range #2 (“FR2”) (i.e., frequencies from 24.25 GHz to 52.6 GHz) is gaining momentum. Accordingly, new techniques for beam management for unicast SL transmission may be needed for SL operation in higher frequencies. For example, the beam establishment procedure for SL unicast may need to consider several factors to be able to coexist with NR Release 16 (“Rel-16”) and/or Release 17 (“Rel-17”) SL design.

Disclosed herein are different ways to establish a unicast beam between Tx UE and Rx UE as part of the initial unicast connection establishment procedure, where the beam establishment procedure may be performed before, after, or together with the higher-layer discovery procedure. Also disclosed herein are different reference signal (“RS”) combinations for performing initial beam acquisition.

In a first solution, the Tx UE may perform initial beam pairing as part of the physical (“PHY”) layer discovery phase which could be performed before or together with the higher layer discovery procedure of unicast connection establishment. The Tx UE may initiate initial beam acquisition procedure with a SL RS transmission (e.g., using Channel State Information Reference Signal (“CSI-RS”)) using a default source identity (“ID”)/destination ID within Sidelink Control Information (“SCI”) which may be used for unicast connection establishment purpose. The SCI may include other information related to unicast connection establishment such as application ID, service type, Quality of Service (“QoS”) information, etc.

In the first solution, each CSI-RS resource may be associated to each beam/panel. The number of repetitions may be equal to or greater than the number of available beams/panels and if the number of repetitions is greater than the number of available beams/panels then a Quasi-Co-Location (“QCL”) relationship between CSI-RS resources could be established across repetitions until maximum configured repetitions. A modulo operation requiring determining the CSI-RS index could be provided by an e.g., modulo (CSI-RS Indices, maximum repetition).

In the first solution, the SCI may indicate beam ID/CSI-RS index together with the CSI-RS transmission associated with each beam. The CSI-RS may be Quasi-Co-Located (“QCL'ed”) with the Physical Sidelink Control Channel (“PSCCH”) transmission which may be implicitly specified or can be explicitly indicated in the SCI for, e.g., 4 bits may represent up to 16 beams. The default Transmission Configuration Indicator (“TCI”) state table can be (pre)configured in a resource pool for the purpose of initial beam acquisition and the default CSI-RS resource configuration for initial beam establishment can be (pre)configured in a resource pool, such default CSI-RS resource may be configured with port number, time/frequency resource, etc. The first solution also discloses Uu and SL beam correspondence signaling. As used herein, “Uu” refers to the radio interface between a UE and a base station (e.g., eNB, gNB, etc.). The device-to-device (“D2D”) radio interface between one UE and another UE is referred to as the “PC5” interface.

In a second solution, the beam acquisition procedure may be started after the unicast connection establishment procedure which may be after the Discovery Communication Request (“DCR”) and Direct Communication Accept (“DCA”) message exchange. The CSI-RS resource configuration related information may be exchanged as part of the unicast discovery procedure. In the second solution, the Tx UE may transmit CSI-RS in a standalone manner without any associated Physical Sidelink Shared Channel (“PSSCH”) (i.e., user data) however 1st SCI, 2nd SCI could be transmitted together with CSI-RS using beam sweeping manner containing beam indices.

In a third solution, the beam acquisition procedure may be started after the unicast connection establishment procedure which may be after the DCR and DCA message exchange. The SL-SSB resource configuration related information may be exchanged as part of the unicast discovery procedure.

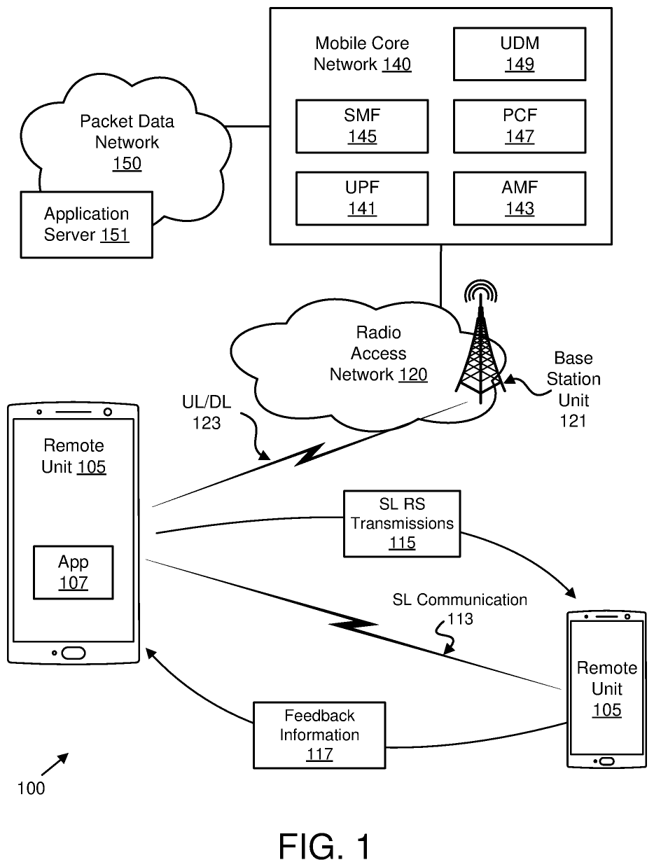

FIG. 1 illustrates an example of a wireless communication system 100 supporting techniques for determining a best beam for SL communication, in accordance with aspects of the present disclosure. The wireless communications system 100 may support various radio access technologies. In some implementations, the wireless communications system 100 may be a 4G network, such as a Long-Term Evolution (“LTE”) network or an LTE-Advanced (“LTE-A”) network. In some other implementations, the wireless communications system 100 may be a 5G network, such as an NR network. In other implementations, the wireless communications system 100 may be a combination of a 4G network and a 5G network, or other suitable radio access technology including Institute of Electrical and Electronics Engineers (“IEEE”) 802.11 (i.e., Wi-Fi), IEEE 802.16 (i.e., WiMAX), IEEE 802.20. The wireless communications system 100 may support radio access technologies beyond 5G. Additionally, the wireless communications system 100 may support technologies, such as time division multiple access (“TDMA”), frequency division multiple access (“FDMA”), or code division multiple access (“CDMA”), etc.

In one embodiment, the wireless communication system 100 includes at least one remote unit 105, a RAN 120, and a mobile core network 140. The RAN 120 and the mobile core network 140 form a mobile communication network. The RAN 120 may be composed of at least one base station unit 121 with which the remote unit 105 communicates using wireless communication links 123. Even though a specific number of remote units 105, RANs 120, base station units 121, wireless communication links 123, and mobile core networks 140 are depicted in FIG. 1, one of skill in the art will recognize that any number of remote units 105, RANs 120, base station units 121, wireless communication links 123, and mobile core networks 140 may be included in the wireless communication system 100.

In one implementation, the RAN 120 is compliant with the 5G cellular system specified in the 3GPP specifications. For example, the RAN 120 may be a Next Generation Radio Access Network (“NG-RAN”), implementing NR RAT and/or LTE RAT. In another example, the RAN 120 may include non-3GPP RAT (e.g., Wi-Fi® or IEEE 802.11-family compliant wireless local area network (“WLAN”)). In another implementation, the RAN 120 is compliant with the LTE system specified in the 3GPP specifications. More generally, however, the wireless communication system 100 may implement some other open or proprietary communication network, for example, the Worldwide Interoperability for Microwave Access (“WiMAX”) or IEEE 802.16-family standards, among other networks. The present disclosure is not intended to be limited to the implementation of any particular wireless communication system architecture or protocol.

In one embodiment, the remote units 105 may include computing devices, such as desktop computers, laptop computers, personal digital assistants (“PDAs”), tablet computers, smart phones, smart televisions (e.g., televisions connected to the Internet), smart appliances (e.g., appliances connected to the Internet), set-top boxes, game consoles, security systems (including security cameras), vehicle on-board computers, network devices (e.g., routers, switches, modems), or the like. In some embodiments, the remote units 105 include wearable devices, such as smart watches, fitness bands, optical head-mounted displays, or the like. Moreover, the remote units 105 may be referred to as the UEs, subscriber units, mobiles, mobile stations, users, terminals, mobile terminals, fixed terminals, subscriber stations, user terminals, wireless transmit/receive unit (“WTRU”), a device, or by other terminology used in the art. In various embodiments, the remote unit 105 includes a subscriber identity and/or identification module (“SIM”) and the mobile equipment (“ME”) providing mobile termination functions (e.g., radio transmission, handover, speech encoding and decoding, error detection and correction, signaling and access to the SIM). In certain embodiments, the remote unit 105 may include a terminal equipment (“TE”) and/or be embedded in an appliance or device (e.g., a computing device, as described above).

The remote units 105 may communicate directly with one or more of the base station units 121 in the RAN 120 via uplink (“UL”) and downlink (“DL”) communication signals. Furthermore, the UL and DL communication signals may be carried over the wireless communication links 123. Furthermore, the UL communication signals may comprise one or more UL channels, such as the Physical Uplink Control Channel (“PUCCH”) and/or Physical Uplink Shared Channel (“PUSCH”), while the DL communication signals may comprise one or more DL channels, such as the Physical Downlink Control Channel (“PDCCH”) and/or Physical Downlink Shared Channel (“PDSCH”). Here, the RAN 120 is an intermediate network that provides the remote units 105 with access to the mobile core network 140.

In various embodiments, the remote units 105 may communicate directly with each other (e.g., device-to-device communication) using SL communication 113. In some embodiments, a first remote unit 105 (i.e., a Tx UE) may configure a SL RS for beam establishment transmission and transmit the SL RS, e.g., by performing a plurality of transmissions 115 of the SL RS with different spatial directions, each of the plurality of transmissions transmitted on one of a plurality of transmit beams.

In some embodiments, a second remote unit 105 (e.g., a Rx UE) receives a SL RS for beam establishment transmission from the first remote unit 105, e.g., by receiving a plurality of transmissions 115 of the SL RS with different spatial directions, each of the plurality of transmissions received on one of a plurality of receive beams. In certain embodiments, the second remote unit 105 determines a best receive beam for SL reception from the received plurality of transmissions and transmits feedback information 117 to the first remote unit 105, where the feedback information indicates the best receive beam and indicates support of beam correspondence at the second remote unit 105.

Accordingly, in certain embodiments, the first remote unit 105 receives feedback information 117 from the second remote unit 105, where the feedback information 117 indicates a best receive beam and indicates support of beam correspondence at the second remote unit 105. In such embodiments, the first remote unit 105 may determine the best transmit beam for SL transmission based on the received feedback transmission. Consequently, the first and second remote units 105 may establish a unicast connection for SL communications 113, where the unicast connection uses the best receive beam and the best transmit beam.

The SL communication 113 may comprise one or more SL channels, such as the PSCCH, the PSSCH, the Physical Sidelink Broadcast Channel (“PSBCH”), and/or the Physical Sidelink Feedback Channel (“PSFCH”). Here, SL transmissions may occur on SL resources. A remote unit 105 may be provided with different SL communication resources according to different allocation modes. For example, in 3GPP systems, allocation Mode-1 corresponds to a NR-based network-scheduled SL communication mode, wherein the in-coverage RAN 120 indicates resources for use in SL operation, including resources of one or more resource pools. Allocation Mode-2 corresponds to a NR-based UE-scheduled SL communication mode (i.e., UE-autonomous selection), where the remote unit 105 selects a resource pools and resources therein from a set of candidate pools. Allocation Mode-3 corresponds to an LTE-based network-scheduled SL communication mode. Allocation Mode-4 corresponds to an LTE-based UE-scheduled SL communication mode (i.e., UE-autonomous selection).

As used herein, a “resource pool” refers to a set of resources assigned for SL operation. A resource pool consists of a set of RBs (i.e., Physical Resource Blocks (“PRBs”)) over one or more time units (e.g., subframe, slots, Orthogonal Frequency Division Multiplexing (“OFDM”) symbols). In some embodiments, the set of RBs comprises contiguous PRBs in the frequency domain. A Physical Resource Block (“PRB”), as used herein, consists of twelve consecutive subcarriers in the frequency domain.

In some embodiments, the remote units 105 communicate with an application server 151 via a network connection with the mobile core network 140. For example, an application 107 (e.g., web browser, media client, telephone and/or Voice-over-Internet-Protocol (“VoIP”) application) in a remote unit 105 may trigger the remote unit 105 to establish a protocol data unit (“PDU”) session (or Packet Data Network (“PDN”) connection) with the mobile core network 140 via the RAN 120. The PDU session represents a logical connection between the remote unit 105 and the User Plane Function (“UPF”) 141. The mobile core network 140 then relays traffic between the remote unit 105 and the application server 151 in the packet data network 150 using the PDU session (or other data connection).

In order to establish the PDU session (or PDN connection), the remote unit 105 must be registered with the mobile core network 140 (also referred to as “attached to the mobile core network” in the context of a 4G system). Note that the remote unit 105 may establish one or more PDU sessions (or other data connections) with the mobile core network 140. As such, the remote unit 105 may have at least one PDU session for communicating with the packet data network 150. The remote unit 105 may establish additional PDU sessions for communicating with other data networks and/or other communication peers.

In the context of a 5G system (“5GS”), the term “PDU Session” refers to a data connection that provides end-to-end (“E2E”) user plane (“UP”) connectivity between the remote unit 105 and a specific Data Network (“DN”) through the UPF 141. A PDU Session supports one or more QoS Flows. In certain embodiments, there may be a one-to-one mapping between a QoS Flow and a QoS profile, such that all packets belonging to a specific QoS Flow have the same 5G QoS Identifier (“5QI”).

In the context of a 4G/LTE system, such as the Evolved Packet System (“EPS”), a PDN connection (also referred to as EPS session) provides E2E UP connectivity between the remote unit and a PDN. The PDN connectivity procedure establishes an EPS Bearer, i.e., a tunnel between the remote unit 105 and a PDN Gateway (“PGW”) (not shown in FIG. 1) in the mobile core network 140. In certain embodiments, there is a one-to-one mapping between an EPS Bearer and a QoS profile, such that all packets belonging to a specific EPS Bearer have the same QoS Class Identifier (“QCI”).

The base station units 121 may be distributed over a geographic region. In certain embodiments, a base station unit 121 may also be referred to as an access terminal, an access point, a base, a base station, a Node-B (“NB”), an Evolved Node B (abbreviated as eNodeB or “eNB,” also known as Evolved Universal Terrestrial Radio Access Network (“E-UTRAN”) Node B), a 5G/NR Node B (“gNB”), a Home Node-B, a relay node, a RAN node, or by any other terminology used in the art. The base station units 121 are generally part of a RAN, such as the RAN 120, that may include one or more controllers communicably coupled to one or more corresponding base station units 121. These and other elements of radio access network are not illustrated but are well known generally by those having ordinary skill in the art. The base station units 121 connect to the mobile core network 140 via the RAN 120.

The base station units 121 may serve a number of remote units 105 within a serving area, for example, a cell or a cell sector, via a wireless communication link 123. The base station units 121 may communicate directly with one or more of the remote units 105 via communication signals. Generally, the base station units 121 transmit DL communication signals to serve the remote units 105 in the time, frequency, and/or spatial domain. Furthermore, the DL communication signals may be carried over the wireless communication links 123. The wireless communication links 123 may be any suitable carrier in licensed or unlicensed radio spectrum. The wireless communication links 123 facilitate communication between one or more of the remote units 105 and/or one or more of the base station units 121.

Note that during NR operation on unlicensed spectrum (referred to as “NR-U”), the base station unit 121 and the remote unit 105 communicate over unlicensed (i.e., shared) radio spectrum. Similarly, during LTE operation on unlicensed spectrum (referred to as “LTE-U”), the base station unit 121 and the remote unit 105 also communicate over unlicensed (i.e., shared) radio spectrum.

In one embodiment, the mobile core network 140 is a 5G Core network (“5GC”) or an Evolved Packet Core (“EPC”), which may be coupled to a packet data network 150, like the Internet and private data networks, among other data networks. A remote unit 105 may have a subscription or other account with the mobile core network 140. In various embodiments, each mobile core network 140 belongs to a single mobile network operator (“MNO”) and/or Public Land Mobile Network (“PLMN”). The present disclosure is not intended to be limited to the implementation of any particular wireless communication system architecture or protocol.

The mobile core network 140 includes several network functions (“NFs”). As depicted, the mobile core network 140 includes at least one UPF 141. The mobile core network 140 also includes multiple control plane (“CP”) functions including, but not limited to, an Access and Mobility Management Function (“AMF”) 143 that serves the RAN 120, a Session Management Function (“SMF”) 145, a Policy Control Function (“PCF”) 147, a Unified Data Management function (“UDM”) and a User Data Repository (“UDR”). In some embodiments, the UDM is co-located with the UDR, depicted as combined entity “UDM/UDR” 149. Although specific numbers and types of network functions are depicted in FIG. 1, one of skill in the art will recognize that any number and type of network functions may be included in the mobile core network 140.

The UPF(s) 141 is/are responsible for packet routing and forwarding, packet inspection, QoS handling, and external PDU session for interconnecting DN, in the 5G architecture. The AMF 143 is responsible for termination of Non-Access Stratum (“NAS”) signaling, NAS ciphering and integrity protection, registration management, connection management, mobility management, access authentication and authorization, security context management. The SMF 145 is responsible for session management (i.e., session establishment, modification, release), remote unit (i.e., UE) Internet Protocol (“IP”) address allocation and management, DL data notification, and traffic steering configuration of the UPF 141 for proper traffic routing.

The PCF 147 is responsible for unified policy framework, providing policy rules to CP functions, access subscription information for policy decisions in UDR. The UDM is responsible for generation of Authentication and Key Agreement (“AKA”) credentials, user identification handling, access authorization, subscription management. The UDR is a repository of subscriber information and may be used to service a number of network functions. For example, the UDR may store subscription data, policy-related data, subscriber-related data that is permitted to be exposed to third party applications, and the like.

In various embodiments, the mobile core network 140 may also include a Network Repository Function (“NRF”) (which provides Network Function (“NF”) service registration and discovery, enabling NFs to identify appropriate services in one another and communicate with each other over Application Programming Interfaces (“APIs”)), a Network Exposure Function (“NEF”) (which is responsible for making network data and resources easily accessible to customers and network partners), an Authentication Server Function (“AUSF”), or other NFs defined for the 5GC. When present, the AUSF may act as an authentication server and/or authentication proxy, thereby allowing the AMF 143 to authenticate a remote unit 105. In certain embodiments, the mobile core network 140 may include an authentication, authorization, and accounting (“AAA”) server.

In various embodiments, the mobile core network 140 supports different types of mobile data connections and different types of network slices, wherein each mobile data connection utilizes a specific network slice. Here, a “network slice” refers to a portion of the mobile core network 140 optimized for a certain traffic type or communication service. For example, one or more network slices may be optimized for enhanced mobile broadband (“eMBB”) service. As another example, one or more network slices may be optimized for ultra-reliable low-latency communication (“URLLC”) service. In other examples, a network slice may be optimized for machine-type communication (“MTC”) service, massive MTC (“mMTC”) service, Internet-of-Things (“IoT”) service. In yet other examples, a network slice may be deployed for a specific application service, a vertical service, a specific use case, etc.

A network slice instance may be identified by a single-network slice selection assistance information (“S-NSSAI”) while a set of network slices for which the remote unit 105 is authorized to use is identified by network slice selection assistance information (“NSSAI”). Here, “NSSAI” refers to a vector value including one or more S-NSSAI values. In certain embodiments, the various network slices may include separate instances of network functions, such as the SMF 145 and UPF 141. In some embodiments, the different network slices may share some common network functions, such as the AMF 143. The different network slices are not shown in FIG. 1 for ease of illustration, but their support is assumed.

While FIG. 1 illustrates components of a 5G RAN and a 5G core network, the described embodiments for determining a best beam for SL communication apply to other types of communication networks and RATs, including IEEE 802.11 variants, Global System for Mobile Communications (“GSM”) (i.e., a 2G digital cellular network), General Packet Radio Service (“GPRS”), Universal Mobile Telecommunications System (“UMTS”), LTE variants, CDMA2000, Bluetooth, ZigBee, Sigfox, and the like.

Moreover, in an LTE variant where the mobile core network 140 is an EPC, the depicted network functions may be replaced with appropriate EPC entities, such as a Mobility Management Entity (“MME”), a Serving Gateway (“SGW”), a PGW, a Home Subscriber Server (“HSS”), and the like. For example, the AMF 143 may be mapped to an MME, the SMF 145 may be mapped to a control plane portion of a PGW and/or to an MME, the UPF 141 may be mapped to an SGW and a user plane portion of the PGW, the UDM/UDR 149 may be mapped to an HSS, etc.

In the following descriptions, the term “RAN node” is used for the base station/base station unit, but it is replaceable by any other radio access node or entity, e.g., gNB, ng-eNB, eNB, Base Station (“BS”), Access Point (“AP”), NR BS, 5G NB, Transmission and Reception Point (“TRP”), base unit, etc. Additionally, the term “UE” is used for the mobile station/remote unit, but it is replaceable by any other remote device, e.g., remote unit, MS, ME, etc. Further, the operations are described mainly in the context of 5G NR. However, the below described solutions/techniques are also equally applicable to other mobile communication systems for determining a best beam for SL communication.

In the following, instead of “slot,” the terms “mini-slot,” “subslot,” or “aggregated slots” can also be used, wherein the notion of slot/mini-slot/sub-slot/aggregated slots can be described as defined in 3GPP Technical Specification (“TS”) 38.211, TS 38.213, and/or TS 38.214.

Several solutions for determining a best beam for SL communication are described below. According to a possible embodiment, one or more elements or features from one or more of the described solutions may be combined.

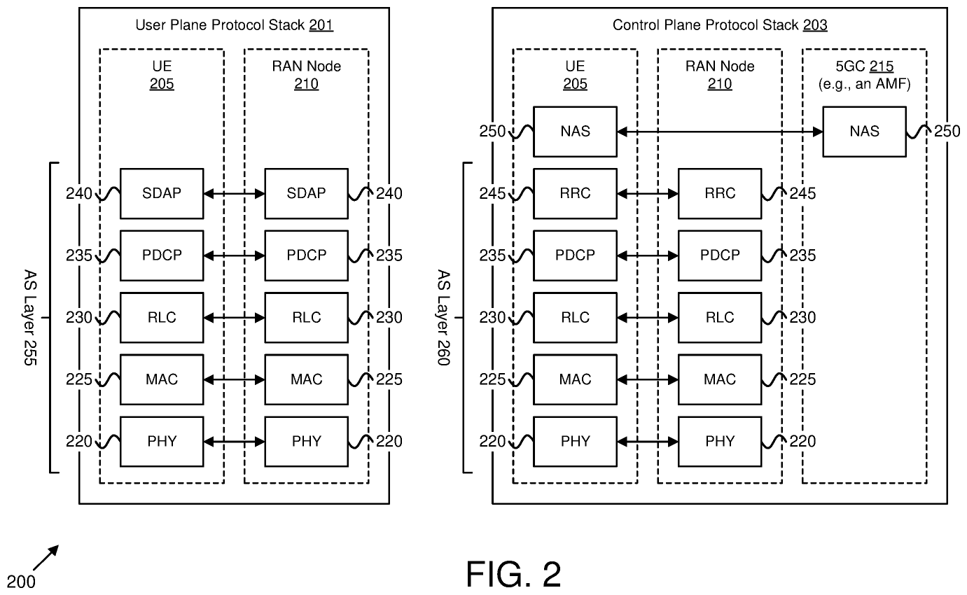

FIG. 2 illustrates an example of an NR protocol stack 200, in accordance with aspects of the present disclosure. While FIG. 2 shows the UE 205, the RAN node 210 and a 5GC 215, e.g., comprising an AMF, these are representatives of a set of remote units 105 interacting with a base station unit 121 and a mobile core network 140. As depicted, the NR protocol stack 200 comprises a User Plane protocol stack 201 and a Control Plane protocol stack 203. The User Plane protocol stack 201 includes a PHY layer 220, a Medium Access Control (“MAC”) layer 225, the Radio Link Control (“RLC”) layer 230, a Packet Data Convergence Protocol (“PDCP”) layer 235, and Service Data Adaptation Protocol (“SDAP”) layer 240. The Control Plane protocol stack 203 includes a PHY layer 220, a MAC layer 225, an RLC layer 230, and a PDCP layer 235. The Control Plane protocol stack 203 also includes a Radio Resource Control (“RRC”) layer 245 and a NAS layer 250. The Access Stratum (“AS”) layer 255 (also referred to as “AS protocol stack”) for the User Plane protocol stack 201 is comprised by at least the SDAP layer 240, the PDCP layer 235, the RLC layer 230, the MAC layer 225, and the PHY layer 220. The AS layer 260 for the Control Plane protocol stack 203 is comprised of at least the RRC layer 245, the PDCP layer 235, the RLC layer 230, the MAC layer 225, and the PHY layer 220. The Layer-1 (“L1”) comprises the PHY layer 220. The Layer-2 (“L2”) is split into the SDAP layer 240, the PDCP layer 235, the RLC layer 230, and the MAC layer 225. The Layer-3 (“L3”) includes the RRC layer 245 and the NAS layer 250 for the control plane and includes, e.g., an IP layer and/or PDU Layer (not shown in FIG. 1) for the user plane. L1 and L2 are referred to as “lower layers,” while L3 and above (e.g., transport layer, application layer) are referred to as “higher layers” or “upper layers.”

The PHY layer 220 offers transport channels to the MAC layer 225. The PHY layer 220 may perform a Clear Channel Assessment (“CCA”) and/or Listen-Before-Talk (“LBT”) procedure using energy detection thresholds. In certain embodiments, the PHY layer 220 may send an indication of beam failure to a MAC entity at the MAC layer 225. In certain embodiments, the PHY layer 220 may send a notification of LBT failure to a MAC entity at the MAC layer 225. The MAC layer 225 offers logical channels to the RLC layer 230. The RLC layer 230 offers RLC channels to the PDCP layer 235. The PDCP layer 235 offers radio bearers to the SDAP layer 240 and/or RRC layer 245. The SDAP layer 240 maps QoS flows within a PDU Session to a corresponding Data Radio Bearer (“DRB”) over the air (e.g., radio) interface and the SDAP layer 240 interfaces with the QoS flows to the 5GC 215 (e.g., to the UPF 141). The RRC layer 245 provides functions for the addition, modification, and release of Carrier Aggregation and/or Dual Connectivity. The RRC layer 245 also manages the establishment, configuration, maintenance, and release of Signaling Radio Bearers (“SRBs”) and DRBs.

The NAS layer 250 is between the UE 205 and an AMF in the 5GC 215. NAS messages are passed transparently through the RAN. The NAS layer 250 is used to manage the establishment of communication sessions and for maintaining continuous communications with the UE 205 as it moves between different cells of the RAN. In contrast, the AS layers 255 and 260 are between the UE 205 and the RAN (i.e., RAN node 210) and carry information over the wireless portion of the network. While not depicted in FIG. 2, the IP layer exists above the NAS layer 250, a transport layer exists above the IP layer, and an application layer exists above the transport layer.

The MAC layer 225 is the lowest sublayer in the L2 architecture of the NR protocol stack. Its connection to the PHY layer 220 below is through transport channels, and the connection to the RLC layer 230 above is through logical channels. The MAC layer 225 therefore performs multiplexing and demultiplexing between logical channels and transport channels: the MAC layer 225 in the transmitting side constructs MAC PDUs (also known as transport blocks (“TBs”)) from MAC Service Data Units (“SDUs”) received through logical channels, and the MAC layer 225 in the receiving side recovers MAC SDUs from MAC PDUs received through transport channels.

The MAC layer 225 provides a data transfer service for the RLC layer 230 through logical channels, which are either control logical channels which carry control data (e.g., RRC signaling) or traffic logical channels which carry user plane data. On the other hand, the data from the MAC layer 225 is exchanged with the PHY layer 220 through transport channels, which are classified as UL or DL. Data is multiplexed into transport channels depending on how it is transmitted over the air.

The PHY layer 220 is responsible for the actual transmission of data and control information via the air interface, i.e., the PHY layer 220 carries all information from the MAC transport channels over the air interface on the transmission side. Some of the important functions performed by the PHY layer 220 include coding and modulation, link adaptation (e.g., Adaptive Modulation and Coding (“AMC”)), power control, cell search and random access (for initial synchronization and handover purposes) and other measurements (inside the 3GPP system (i.e., NR and/or LTE system) and between systems) for the RRC layer 245. The PHY layer 220 performs transmissions based on transmission parameters, such as the modulation scheme, the coding rate (i.e., the modulation and coding scheme (“MCS”)), the number of PRBs, etc.

In some embodiments, the UE 205 may support an LTE protocol stack. Note that an LTE protocol stack comprises similar structure to the NR protocol stack 200, with the differences that the LTE protocol stack lacks the SDAP layer 240 in the AS layer 255 and that the NAS layer 250 is between the UE 205 and an MME in the EPC.

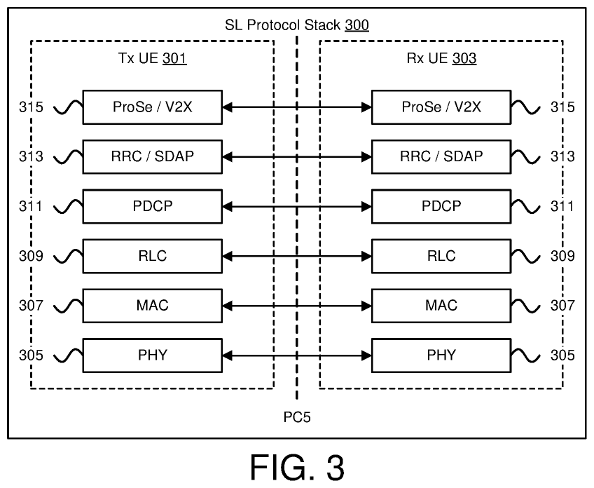

FIG. 3 illustrates a SL protocol stack 300, in accordance with aspects of the present disclosure. While FIG. 3 shows a Tx UE 301 and a Rx UE 303, these are representative of a set of UEs using SL communication over a PC5 interface: other embodiments may involve different SL UEs. In various embodiments, each of the Tx UE 301 and a Rx UE 303 may be an embodiment of the remote unit 105 and/or UE 205.

As depicted, the SL protocol stack (i.e., PC5 protocol stack) includes a PHY layer 305, a MAC layer 307, a RLC layer 309, a PDCP layer 311, a SDAP layer 240 (e.g., for the user plane), and an RRC layer 245 (e.g., for the control plane). In FIG. 3, the SDAP layer 240 and RRC layer 245 are depicted as combined entity “RRC/SDAP layers” 313. There may be additional layers above the RRC/SDAP layers 313, such as a Proximity Services (“ProSe”) and/or V2X application layer 315.

The AS layer (also referred to as “AS protocol stack”) for the control plane in the PC5 interface consists of at least the RRC layer 245, the PDCP layer 311, the RLC layer 309, the MAC layer 307, and the PHY layer 305. The AS layer (also referred to as “AS protocol stack”) for the user plane in the PC5 interface consists of at least the SDAP layer 240, the PDCP layer 311, the RLC layer 309, the MAC layer 307, and the PHY layer 305.

The L1 refers to the PHY layer 305. The L2 is split into the SDAP layer 240, the PDCP layer 311, the RLC layer 309, and the MAC layer 307. The L3 includes the RRC layer 245 for the control plane and includes, e.g., an IP layer or PDU Layer (not depicted) for the user plane. L1 and L2 are generally referred to as “lower layers,” while L3 and above (e.g., transport layer, V2X layer, application layer) are referred to as “higher layers” or “upper layers.” The PHY layer 305, the MAC layer 307, the RLC layer 309, and the PDCP layer 311 perform similar functions as the PHY layer 220, the MAC layer 225, the RLC layer 230, and the PDCP layer 235, described above with reference to FIG. 2.

In various embodiments, the SL communication 113 relates to one or more services requiring SL connectivity, such as V2X services and ProSe services. The Tx UE 301 may establish one or more SL connections with nearby Rx UEs 303. For example, a V2X application running on the Tx UE 301 may generate data relating to a V2X service and use a SL connection to transmit the V2X data to one or more nearby Rx UEs 303.

A “UE panel” or “antenna panel” may be a logical entity with physical UE antennas mapped to the logical entity. How to map physical UE antennas to the logical entity may be up to UE implementation. Depending on UE's own implementation, a “UE panel” can have at least one of the following functionalities as an operational role of Unit of antenna group to control its Tx beam independently, Unit of antenna group to control its transmission power independently, Unit of antenna group to control its transmission timing independently. The “UE panel” may be transparent to gNB.

For certain condition(s), gNB or network can assume the mapping between UE's physical antennas to the logical entity “UE panel” may not be changed. For example, the condition may include until the next update, report from UE, or comprise a duration of time over which the gNB assumes there will be no change to the mapping. UE may report its UE capability with respect to the “UE panel” to the gNB or network. The UE capability may include at least the number of “UE panels.” In one implementation, the UE may support UL transmission from one beam within a panel: with multiple panels, more than one beam (one beam per panel) may be used for UL transmission. In another implementation, more than one beam per panel may be supported/used for UL transmission.

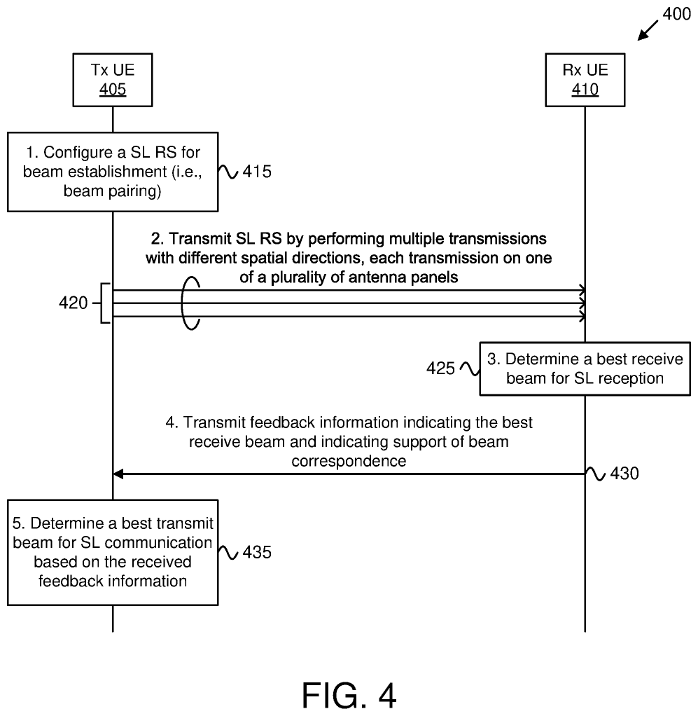

FIG. 4 illustrates an exemplary procedure 400 for beam pairing to establish a unicast beam, in accordance with aspects of the present disclosure. The procedure 400 involves a Tx UE 405 (e.g., one embodiment of the Tx UE 301) and an Rx UE 410 (e.g., one embodiment of the Rx UE 303) in a mobile communication network.

At Step 1, the Tx UE 405 configures a SL RS for beam establishment (see operation 415).

At Step 2, the Tx UE 405 transmits the SL RS (see operation 420). The Tx UE 405 performs a plurality of transmissions of the SL RS with different spatial directions, each of the plurality of transmissions on one of a plurality of beams.

At Step 3, the Rx UE 410 determines a best receive beam for SL reception from the received plurality of transmissions (see operation 425).

At Step 4, the Rx UE 410 transmits feedback information to the Tx UE 405 (see operation 430). Here, the feedback information indicates the best receive beam and indicates support of beam correspondence at the Rx UE 410.

At Step 5, the Tx UE 405 determining a best beam for SL transmission based on the received feedback transmission (see operation 435).

According to the embodiments of the first solution, the Tx UE 405 and the Rx UE 410 may perform beam pairing to establish a unicast beam as part of initial connection establishment.

In some embodiments, the Tx UE 405 may perform beam pairing as part of the PHY discovery phase, which could be performed before or together with the higher layer discovery procedure of unicast connection establishment. The Tx UE 405 may initiate initial a beam acquisition procedure with SL RS transmission (e.g., CSI-RS) using a default source ID and/or default destination ID within SCI, which may be used for unicast connection establishment purpose.

In some embodiments, the Tx UE 405 may beam sweep the SCI and SL RS transmission and the SCI may carry other relevant information to identify the Rx UE 410 such as Service Type, Application ID of the initiator UE (i.e., Tx UE 405) and the target UE (i.e., the Rx UE 410), QoS information, etc.

In one implementation, a SL resource pool may be (pre)configured with the SCI and/or SL RS monitoring period to aid initial beam establishment. In various embodiments, a DCR message may be transmitted along with the SCI and the SL RS, where the SL RS may be embedded within the DCR message.

In another implementation, a separate resource pool could be (pre)configured for transmitting DCR message or SL RS transmission for beam establishment purpose.

In certain embodiment of the first solution, the DCR message may be transmitted using a MAC control element (“CE”). In such embodiments, the MAC CE, SCI, and SL RS may be transmitted together in the same slot. Other relevant information, such as Service Type and Application ID, may be transmitted using MAC CE.

In some embodiments of the first solution, the CSI-RS may be confined within a data region of the DCR message, which may be transmitted by Tx UE in beam sweeping manner (i.e., a combination of different spatial direction and time domain repetition). Here, each CSI-RS resource may be associated to each beam/panel. In certain embodiments, the number of repetitions may be greater than or equal to the number of available beams/panels. If the number of repetitions is greater than the number of available beams/panels, then a QCL relationship between CSI-RS resources could be established across repetitions until maximum configured repetitions. Further, a modulo operation for determining the CSI-RS index could be provided, for example: modulo (CSI-RS Indices, maximum repetition).

In another implementation, repeating the entire DCR message may be resource inefficient and hence the repetition may be performed with a smaller message size. In such embodiments, SCI and the SL RS may be transmitted together with the reduced DCR message.

In some embodiments, the SCI may indicate a beam ID/CSI-RS index together with the CSI-RS transmission associated with each beam. The CSI-RS may be QCL'ed with a PSCCH transmission, which may be implicitly specified or can be explicitly indicated in the SCI, for example using 4 bits to indicate one of (up to) 16 beams.

In certain embodiments, a default TCI state table may be (pre)configured in a resource pool for the purpose of initial beam acquisition, while the index of the TCI state could be signaled in the SCI and the default CSI-RS resource configuration for initial beam establishment can be (pre)configured in a resource pool, such default CSI-RS resource may be configured with port number, time/frequency resource, etc., and signaled in semi-statically in PC5-RRC, MAC CE or dynamically in SCI.

The Rx UE 410 may transmit the CSI-RS using beam correspondence to select the transmit beam according to the receive beam for transmitting DCA message. If the Rx UE 410 does not support beam correspondence, then the Rx UE 410 may transmit the message and/or RS using beam sweeping manner.

In certain embodiments, the UE capability on the beam correspondence may be exchanged between the Tx UE 405 and the Rx UE 410 along with the transmission of the DCR and the DCA messages: otherwise, the PHY layer 305 needs to exchange the Beam correspondence capability information in SCI or MAC CE. Note that if a UE supports beam correspondence on the Uu interface, then the same UE may also support beam correspondence on SL: hence, a separate beam correspondence support indication may not be required for Uu and SL. However, if a UE does not support beam correspondence on the Uu interface, then it may be assumed that the same UE also does not support beam correspondence on SL.

In some embodiments, the Tx UE 405 performs beam sweeping reception using the same pattern as that of transmission to receive the ‘direct communication accept message’ and/or CSI-RS to establish beam pair. In certain embodiments, if the beam sweeping pattern of the Rx UE 410 is different from that of the Tx UE 405, then the Rx UE 410 could report the CSI-RS index by using PHY layer signaling or higher layer signaling.

According to embodiment of a second solution, beam acquisition may be performed after the discovery phase, e.g., by reusing CSI-RS. The beam acquisition procedure may be started after the unicast connection establishment procedure which may be after the DCR and DCA message exchange. In some embodiments, the CSI-RS resource configuration related information may be exchanged as part of the unicast discovery procedure. The beam acquisition procedure could be performed before the transmission of first PSSCH to the destination UE with the following:

First, the Tx UE 405 may transmit CSI-RS in a standalone manner without any associated PSSCH (user data) however 1st SCI, 2nd SCI could be transmitted together with CSI-RS using beam sweeping manner containing beam indices.

Second, the Rx UE 410 transmits the CSI-RS using beam correspondence: if beam correspondence not supported, then the Rx UE transmits CSI-RS in a beam sweeping manner.

In another implementation, the beam acquisition procedure may be performed with the first PSSCH transmission, i.e., user data which means CSI-RS could be transmitted within the PSSCH region using beam sweeping.

According to embodiments of a third solution, beam acquisition may be performed during and/or after the discovery phase, e.g., using a modified SCI+SL-SSB framework. The beam acquisition procedure may be started after the unicast connection establishment procedure which may be after the DCR and DCA message exchange. In some embodiments, the SL-SSB resource configuration related information may be exchanged as part of the unicast discovery procedure. After the discovery phase using the omnidirectional manner and before the transmission of first PSSCH to the destination UE the beam acquisition procedure is needed with the following

In one implementation, in the SL-SSB the PSBCH content may include beam/panel index and the SCI indicating the time/frequency resource of Synchronization Signal Block (“SSB”) may be transmitted together with the SL-SSB. The frame structure of the SL-SSB is changed with the mapping of SCI at the beginning of the slot followed by Sidelink Primary Synchronization Signal (“S-PSS”), Sidelink Secondary Synchronization Signal (“S-SSS”) and PSBCH. The beam indices may be indicated using a combination of different sequences of S-PSS and S-SSS.

In another implementation, as part of the unicast connection establishment procedure resource configuration of a Zadoff-Chu sequence, sequence length, base sequence configuration, a cyclic shift etc., may be exchanged and the beam indices may be indicated using a combination of different cyclic shifts of the Zadoff-Chu sequence. Such Zadoff-Chu sequence may be transmitted together with SCI implicitly or explicitly indicating the beam indices.

In another implementation, the resource configuration may be (pre)configured in a resource pool.

According to embodiment of a fourth solution, beam acquisition may be performed using combination during and after discovery phase. In some embodiments, the beam acquisition procedure may be started after the unicast connection establishment procedure which may be after the DCR and DCA message exchange while the selection of antenna panel may be performed during the discovery phase. Moreover, in certain embodiments, establishing the beam pair may be performed after the discovery phase. The Tx UE 405 may remember the beam used for transmission and reception for each L2 source ID and L2 destination ID pair for resource allocation procedure.

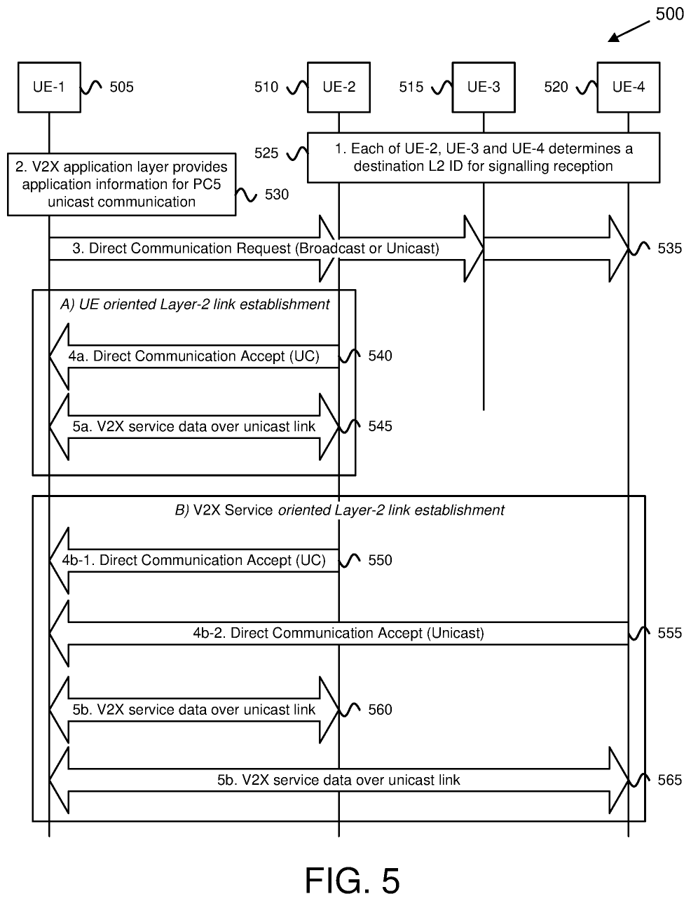

FIG. 5 illustrates an exemplary procedure 500 for Layer-2 link establishment procedure for unicast mode of V2X communication over PC5 reference point, in accordance with aspects of the present disclosure. The procedure 500 and involves a first V2X UE (denoted as “UE-1”) 505, a second V2X UE (denoted as “UE-2”) 510, a third V2X UE (denoted as “UE-3”) 515 and a fourth V2X UE (denoted as “UE-4”) 520. Each UE may be one embodiment of the remote unit 105 and/or the UE 205. Moreover, the UE-1 505 may be an embodiment of the Tx UE 405 and/or Tx UE 301, while the UE-2 510, the UE-3 515 and the UE-4 520 may each be embodiments of the Rx UE 410 and/or Rx UE 303. In certain embodiments, the procedure 500 utilizes PC5 Signaling (“PC5-S”) protocol.

At Step 1, each of the UE-2 510, the UE-3 515 and the UE-4 520 determines (e.g., self-assigns) its destination Layer-2 (“L2”) ID for signaling reception for PC5 unicast link establishment (see operation 525). The destination Layer-2 ID is configured with the UEs. While not depicted in FIG. 5, the UE-1 505 may also self-assign its source L2 ID for the PC5 unicast link.

In various embodiments, the self-assigned L2 IDs may be selected based on an associated service, such as a V2X service type and/or ProSe/V2X service. In some embodiments, a UE may be configured by the network (i.e., RAN and/or PLMN) with certain destination L2 IDs. For example, a UE may be configured with a mapping of V2X service types (and/or ProSe/V2X services) to default Destination L2 ID(s) for initial signaling to establish unicast connection. Additionally, the UE may be configured with a mapping of V2X service types (and/or ProSe/V2X services) to Destination L2 ID(s) for broadcast and a mapping of V2X service types to Destination L2 ID(s) for groupcast mode communication. Still further, the configuration may map V2X service types (and/or ProSe/V2X services) to the default mode of communication (i.e., broadcast mode, groupcast mode or unicast mode) and/or map V2X service types (and/or ProSe/V2X services) to operational frequencies (e.g., V2X frequencies) with corresponding Geographical Area(s).

At Step 2, having as example SL communication for V2X services, the V2X application layer of the UE-1 505 provides application information for PC5 unicast communication (see operation 530). The application information may include the service type(s) (e.g., Provider Service Identifier (“PSID”) or Intelligent Transportation Systems Application Identifier (“ITS-AID”)) of the V2X application and the initiating UE's Application Layer ID. The target UE's Application Layer ID may also be included in the application information.

Accordingly, the upper layers (e.g., ProSe/V2X layer 315) at the UE-1 505 initiate a PC5 unicast link establishment. During unicast link establishment procedure, the UE-1 505 sends its source L2 ID for the PC5 unicast link to the peer UE(s), i.e., the UE(s) for which a destination ID has been received from the upper layers.

The V2X application layer in the UE-1 505 may provide service requirements for this unicast communication. The UE-1 505 determines the PC5 QoS parameters and PC5 QoS Flow Indicator (“PFI”). If the UE-1 505 decides to reuse the existing PC5 unicast link, the UE triggers Layer-2 link modification procedure.

At Step 3, the UE-1 505 sends a Direct Communication Request (i.e., a PC5-S message) to initiate the unicast Layer-2 link establishment procedure (see operation 535).

The Direct Communication Request contains source user information (Source User Info), V2X service information (V2X Service Info), an indication of whether IP communication is used, an IP Address Configuration (note that for IP communication, an IP address configuration is required for this link), and QoS information (QoS Info). If the V2X application layer provided the target UE's Application Layer ID in step 2, then target user information (Target User Info) may also be included in the Direct Communication Request. Here, the target UE's Application Layer ID (i.e., UE-2's Application Layer ID).

The source user information may include the initiating UE's Application Layer ID (i.e., UE-1's Application Layer ID). The V2X service information includes information about V2X Service(s) requesting Layer-2 link establishment (e.g., PSID(s) or ITS-AID(s)). The QoS information includes information about PC5 QoS Flow(s). For each PC5 QoS Flow, the PFI and the corresponding PC5 QoS parameters. In certain embodiments, the corresponding PC5 QoS parameters may include a PC5 QoS Indicator (“PQI”) and conditionally other parameters such as Maximum Flow Bit Rate (“MFBR”), Guaranteed Flow Bit Rate (“GFBR”), etc.

The source Layer-2 ID and destination Layer-2 ID used to send the Direct Communication Request message are determined, e.g., as specified in clauses 5.6.1.1 and 5.6.1.4. The UE-1 505 sends the Direct Communication Request message via PC5 broadcast using the source Layer-2 ID and the destination Layer-2 ID.

The receiving UEs (i.e., UE-2 510, UE-3 515 and UE-4 520) verify whether the destination ID belongs to it, if yes decide whether they are interested in establishing a unicast connection with the UE-1 505 (e.g., by interfacing with a local instance of the V2X application). In certain embodiments, interested UE(s) exchange security information to establish a secure link and negotiate the QoS.

As depicted, there are different options for establishing a L2 link between SL UEs. As a first option (denoted as “Option A”), the L2 link establishment is UE oriented. Alternatively, as a second option (denoted as “Option B”), the L2 link establishment is V2X service oriented.

According to Option A (i.e., UE oriented Layer-2 link establishment), at Step 4a if the Target User Info is included in the Direct Communication Request message, the target UE, i.e., UE-2 responds with a DCA message.

In the depicted embodiment, the UE-2 510 decides to establish a unicast (“UC”) connection. The UE-2 510 accepts the Unicast link establishment request by responding with a DCA message (see operation 540).

The DCA message includes source user information (Source User Info) and QoS information (QoS Info). The source user information includes the Application Layer ID of the UE sending the DCA message. The QoS information includes information about PC5 QoS Flow(s). For each PC5 QoS Flow, the QoS information includes the PFI and the corresponding PC5 QoS parameters (i.e., PQI and conditionally other parameters such as MFBR/GFBR, etc.).

The source Layer-2 ID is used to send the DCA message. The destination Layer-2 ID is set to the source Layer-2 ID of the received Direct Communication Request message. A pair of source L2 ID and destination L2 ID therefore uniquely identifies the unicast link.

Upon receiving the DCA message from a peer UE, the UE-1 505 obtains the Layer-2 ID of the UE-2 510 for future communication, for signaling and data traffic for this unicast link. Note that the pair of source L2 ID and destination L2 ID uniquely identifies the unicast link.

The V2X layer of the UE-1 505 passes the PC5 Link Identifier assigned for the unicast link and PC5 unicast link related information down to the AS layer. The PC5 unicast link related information includes Layer-2 ID information (i.e., source Layer-2 ID, and destination Layer-2 ID). This enables the AS layer to maintain the PC5 Link Identifier together with the PC5 unicast link related information.

At Step 5a, after successful PC5 unicast link establishment, the peer UEs use the same pair of L2 IDs for subsequent V2X service data transmission (see operation 545). The PC5 Link Identifier and PFI are provided to the AS layer, together with the V2X service data. The UE-1 505 sends the V2X service data using the source Layer-2 ID (i.e., UE-1's Layer-2 ID for this unicast link), and the destination Layer-2 ID (i.e., the UE-2's Layer-2 ID for this unicast link).

According to Option B (i.e., V2X Service oriented Layer-2 link establishment), if the Target User Info is not included in the Direct Communication Request message, the UEs that are interested in using the announced V2X Service(s), so decide to establish Layer-2 link with the UE-1 505 respond to the request by sending a DCA message. In the depicted embodiment, the UE-2 510 and UE-4 520 decide to establish a unicast (“UC”) connection.

At Step 4b-1, the UE-2 510 accepts the Unicast link establishment request by responding with a DCA message (see operation 550). Contents of the DCA message are as described above in Option A.

At Step 4b-2, the UE-4 520 accepts the Unicast link establishment request by responding with a DCA message (see operation 555). Contents of the DCA message are as described above in Option A.

Upon receiving the DCA message from a peer UE, the UE-1 505 obtains the peer UE's Layer-2 ID for future communication, for signaling and data traffic for this unicast link. As described above, the V2X layer of the UE-1 505 that established PC5 unicast link passes the PC5 Link Identifier assigned for the unicast link and PC5 unicast link related information down to the AS layer.

At Steps 5b, after successful PC5 unicast link establishment, the peer UEs use the same pair of L2 IDs for subsequent V2X service data transmission (see operations 560 and 565). The PC5 Link Identifier and PFI are provided to the AS layer, together with the V2X service data. The UE-1 505 sends the V2X service data using the source Layer-2 ID (i.e., UE-1's Layer-2 ID for this unicast link), and the destination Layer-2 ID (i.e., the peer UE's Layer-2 ID for this unicast link).

Note that the established PC5 unicast link(s) are bi-directional, therefore the peer UEs can send the V2X service data to UE-1 505 over their unicast links with UE-1 505. Additionally, while FIG. 5 is described in the context of a V2X service, the same procedure can be used for a ProSe service, e.g., where a ProSe application and/or ProSe layer initiates PC5 unicast link establishment.

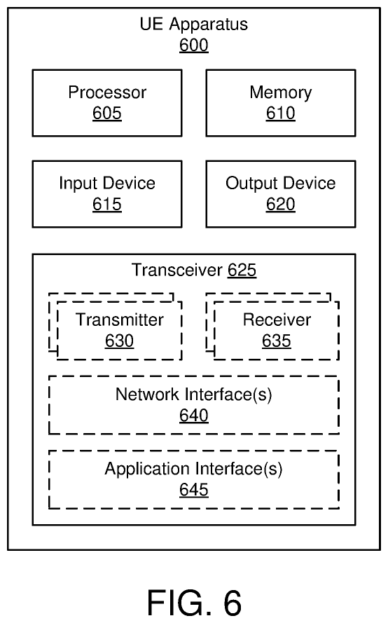

FIG. 6 illustrates an example of a UE apparatus 600 that may be used for determining a best beam for SL communication, in accordance with aspects of the present disclosure. In various embodiments, the UE apparatus 600 is used to implement one or more of the solutions described above. The UE apparatus 600 may be an example of a user endpoint, such as the remote unit 105, the UE 205, the Tx UE 301, the Rx UE 303, the Tx UE 405, and/or the Rx UE 410, as described above. Furthermore, the UE apparatus 600 may include a processor 605, a memory 610, an input device 615, an output device 620, and a transceiver 625.

In some embodiments, the input device 615 and the output device 620 are combined into a single device, such as a touchscreen. In certain embodiments, the UE apparatus 600 may not include any input device 615 and/or output device 620. In various embodiments, the UE apparatus 600 may include one or more of: the processor 605, the memory 610, and the transceiver 625, and may not include the input device 615 and/or the output device 620.

As depicted, the transceiver 625 includes at least one transmitter 630 and at least one receiver 635. In some embodiments, the transceiver 625 communicates with one or more cells (or wireless coverage areas) supported by one or more base station units 121. In various embodiments, the transceiver 625 is operable on unlicensed spectrum. Moreover, the transceiver 625 may include multiple UE panels supporting one or more beams. Additionally, the transceiver 625 may support at least one network interface 640 and/or application interface 645. The application interface(s) 645 may support one or more APIs. The network interface(s) 640 may support 3GPP reference points, such as Uu, N1, PC5, etc. Other network interfaces 640 may be supported, as understood by one of ordinary skill in the art.

The processor 605, in one embodiment, may include any known controller capable of executing computer-readable instructions and/or capable of performing logical operations. For example, the processor 605 may be a microcontroller, a microprocessor, a central processing unit (“CPU”), a graphics processing unit (“GPU”), an auxiliary processing unit (“APU”), a field programmable gate array (“FPGA”), or similar programmable controller. In some embodiments, the processor 605 executes instructions stored in the memory 610 to perform the methods and routines described herein. The processor 605 is communicatively coupled to the memory 610, the input device 615, the output device 620, and the transceiver 625.

In various embodiments, the processor 605 controls the UE apparatus 600 to implement the above-described UE behaviors. In certain embodiments, the processor 605 may include an application processor (also known as “main processor”) which manages application-domain and operating system (“OS”) functions and a baseband processor (also known as “baseband radio processor”) which manages radio functions.

In various embodiments, via the transceiver 625, the processor 605 configures a SL RS for beam establishment transmission and transmits the SL RS, where transmitting includes performing a plurality of transmissions of the SL RS with different spatial directions, each of the plurality of transmissions on one of a plurality of beams. The transceiver 625 receives a feedback transmission from a Rx UE, where the feedback transmission indicates support of beam correspondence at the Rx UE, and the processor 605 determines a best beam for SL transmission based on the received feedback transmission.

In some embodiments, transmitting the SL RS occurs before or concurrent with a discovery procedure for SL unicast connection establishment (e.g., before DCR and DCA message exchange). In other embodiments, transmitting the SL RS occurs after or concurrent with a discovery procedure for SL unicast connection establishment (e.g., after DCR and DCA message exchange).

In some embodiments, the SL RS may include one or more of: a CSI-RS, a SL SSB, a Zadoff-Chu sequence, or a combination thereof. In certain embodiments, the CSI-RS is QCL'ed with a PSCCH transmission.

In some embodiments, the SL RS is transmitted with SCI, SL data (i.e., PSSCH), or a combination thereof. In certain embodiments, the SCI includes assistance information to aid a discovery procedure for SL unicast connection establishment, said assistance information including one or more of: A) a default source ID, B) a default destination ID, C) a service type, D) an application ID, and/or E) QoS information. In certain embodiments, the SCI includes information related to beam indices of the plurality of beams.

In some embodiments, the received feedback transmission includes a second RS transmission. In some embodiments, the received feedback transmission includes a best received beam ID (e.g., in terms of RS Received Power (“RSRP”)). In some embodiments, the processor further defines a default TCI table in a SL resource pool to indicate a QCL relationship for beam establishment.

In some embodiments, transmitting the SL RS includes transmitting each of the plurality of transmissions from one of a plurality of antenna panels in a different timeslot using a combination of different spatial direction and time domain repetition (i.e., beam sweeping). In certain embodiments, the number of time domain repetitions of the SL RS is less than or equal to the number of available beams/panels.

In certain embodiments, the number of time domain repetitions of the SL RS is greater than the number of available beams/panels. In such embodiments, the processor establishes a QCL relationship between SL RS resources (e.g., CSI-RS resources) and determines a QCL relationship between SL RS repetitions using a modulo operation.

In various embodiments, the transceiver 625 receives the SL RS for beam establishment transmission from a Tx UE. Here, the transceiver 625 receives a plurality of transmissions of the SL RS with different spatial directions, each of the plurality of transmissions on one of a plurality of beams. Via the transceiver 625, the processor 605 determines a best receive beam for SL reception from the received plurality of transmissions and transmits feedback information to the Tx UE, where the feedback information indicates the best receive beam and indicates support of beam correspondence at the Rx UE.

In some embodiments, the SL RS may include one or more of: a CSI-RS, a SL SSB, a Zadoff-Chu sequence, or a combination thereof. In certain embodiments, the CSI-RS is QCL'ed with a PSCCH transmission.

In some embodiments, the SL RS is received with SCI, SL data (i.e., PSSCH), or a combination thereof. In certain embodiments, the SCI includes assistance information to aid a discovery procedure for SL unicast connection establishment, said assistance information containing one or more of: a default source ID, a default destination ID, a service type, an application ID, and QoS information. In certain embodiments, the SCI includes information related to beam indices of the plurality of beams.

In some embodiments, the transmitted feedback information includes a second RS transmission. In some embodiments, the transmitted feedback information includes a best received beam ID (e.g., in terms of RSRP). In some embodiments, the transceiver 625 further receives a resource pool configuration that defines a default TCI table to indicate a QCL relationship for beam establishment.

In some embodiments, receiving the SL RS includes receiving each of the plurality of transmissions at one of a plurality of antenna panels in a different timeslot using a combination of different spatial direction and time domain repetition (i.e., beam sweeping). In certain embodiments, the number of time domain repetitions of the SL RS is less than or equal to the number of available beams/panels.

In certain embodiments, the number of time domain repetitions of the SL RS is greater than the number of available beams/panels. In such embodiments, the processor 605 further receives a QCL relationship between SL RS resources (e.g., CSI-RS resources) and determines a QCL relationship between SL RS repetitions using a modulo operation.

The memory 610, in one embodiment, is a computer readable storage medium. In some embodiments, the memory 610 includes volatile computer storage media. For example, the memory 610 may include a RAM, including dynamic RAM (“DRAM”), synchronous dynamic RAM (“SDRAM”), and/or static RAM (“SRAM”). In some embodiments, the memory 610 includes non-volatile computer storage media. For example, the memory 610 may include a hard disk drive, a flash memory, or any other suitable non-volatile computer storage device. In some embodiments, the memory 610 includes both volatile and non-volatile computer storage media.

In some embodiments, the memory 610 stores data related to beam establishment between a Tx UE and Rx UE and/or mobile operation. For example, the memory 610 may store various parameters, panel/beam configurations, resource assignments, policies, and the like as described above. In certain embodiments, the memory 610 also stores program code and related data, such as an operating system or other controller algorithms operating on the apparatus 600.

The input device 615, in one embodiment, may include any known computer input device including a touch panel, a button, a keyboard, a stylus, a microphone, or the like. In some embodiments, the input device 615 may be integrated with the output device 620, for example, as a touchscreen or similar touch-sensitive display. In some embodiments, the input device 615 includes a touchscreen such that text may be input using a virtual keyboard displayed on the touchscreen and/or by handwriting on the touchscreen. In some embodiments, the input device 615 includes two or more different devices, such as a keyboard and a touch panel.

The output device 620, in one embodiment, is designed to output visual, audible, and/or haptic signals. In some embodiments, the output device 620 includes an electronically controllable display or display device capable of outputting visual data to a user. For example, the output device 620 may include, but is not limited to, a Liquid Crystal Display (“LCD”), a Light-Emitting Diode (“LED”) display, an Organic LED (“OLED”) display, a projector, or similar display device capable of outputting images, text, or the like to a user. As another, non-limiting, example, the output device 620 may include a wearable display separate from, but communicatively coupled to, the rest of the UE apparatus 600, such as a smart watch, smart glasses, a heads-up display, or the like. Further, the output device 620 may be a component of a smart phone, a personal digital assistant, a television, a table computer, a notebook (laptop) computer, a personal computer, a vehicle dashboard, or the like.

In certain embodiments, the output device 620 includes one or more speakers for producing sound. For example, the output device 620 may produce an audible alert or notification (e.g., a beep or chime). In some embodiments, the output device 620 includes one or more haptic devices for producing vibrations, motion, or other haptic feedback. In some embodiments, all or portions of the output device 620 may be integrated with the input device 615. For example, the input device 615 and output device 620 may form a touchscreen or similar touch-sensitive display. In other embodiments, the output device 620 may be located near the input device 615.

The transceiver 625 communicates with one or more network functions of a mobile communication network via one or more access networks. The transceiver 625 operates under the control of the processor 605 to transmit messages, data, and other signals and also to receive messages, data, and other signals. For example, the processor 605 may selectively activate the transceiver 625 (or portions thereof) at particular times in order to send and receive messages.

The transceiver 625 includes at least one transmitter 630 and at least one receiver 635. One or more transmitters 630 may be used to provide UL communication signals to a base station unit 121, such as the UL transmissions described herein. Similarly, one or more receivers 635 may be used to receive DL communication signals from the base station unit 121, as described herein. Although only one transmitter 630 and one receiver 635 are illustrated, the UE apparatus 600 may have any suitable number of transmitters 630 and receivers 635. Further, the transmitter(s) 630 and the receiver(s) 635 may be any suitable type of transmitters and receivers. In one embodiment, the transceiver 625 includes a first transmitter/receiver pair used to communicate with a mobile communication network over licensed radio spectrum and a second transmitter/receiver pair used to communicate with a mobile communication network over unlicensed radio spectrum.

In certain embodiments, the first transmitter/receiver pair used to communicate with a mobile communication network over licensed radio spectrum and the second transmitter/receiver pair used to communicate with a mobile communication network over unlicensed radio spectrum may be combined into a single transceiver unit, for example, a single chip performing functions for use with both licensed and unlicensed radio spectrum. In some embodiments, the first transmitter/receiver pair and the second transmitter/receiver pair may share one or more hardware components. For example, certain transceivers 625, transmitters 630, and receivers 635 may be implemented as physically separate components that access a shared hardware resource and/or software resource, such as for example, the network interface 640.

In various embodiments, one or more transmitters 630 and/or one or more receivers 635 may be implemented and/or integrated into a single hardware component, such as a multi-transceiver chip, a system-on-a-chip, an Application-Specific Integrated Circuit (“ASIC”), or other type of hardware component. In certain embodiments, one or more transmitters 630 and/or one or more receivers 635 may be implemented and/or integrated into a multi-chip module. In some embodiments, other components such as the network interface 640 or other hardware components/circuits may be integrated with any number of transmitters 630 and/or receivers 635 into a single chip. In such embodiment, the transmitters 630 and receivers 635 may be logically configured as a transceiver 625 that uses one or more common control signals or as modular transmitters 630 and receivers 635 implemented in the same hardware chip or in a multi-chip module.

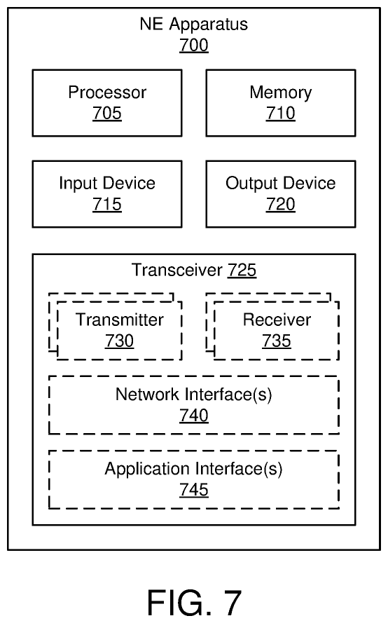

FIG. 7 illustrates an example of a NE apparatus 700 that may be used for determining a best beam for SL communication, in accordance with aspects of the present disclosure. In one embodiment, the NE apparatus 700 may be one implementation of a network endpoint, such as the base station unit 121 and/or RAN node 210, as described above. Furthermore, the NE apparatus 700 may include a processor 705, a memory 710, an input device 715, an output device 720, and a transceiver 725.

In some embodiments, the input device 715 and the output device 720 are combined into a single device, such as a touchscreen. In certain embodiments, the NE apparatus 700 may not include any input device 715 and/or output device 720. In various embodiments, the NE apparatus 700 may include one or more of: the processor 705, the memory 710, and the transceiver 725, and may not include the input device 715 and/or the output device 720.

As depicted, the transceiver 725 includes at least one transmitter 730 and at least one receiver 735. Here, the transceiver 725 communicates with one or more remote units 105. Additionally, the transceiver 725 may support at least one network interface 740 and/or application interface 745. The application interface(s) 745 may support one or more APIs. The network interface(s) 740 may support 3GPP reference points, such as Uu, N1, N2 and N3. Other network interfaces 740 may be supported, as understood by one of ordinary skill in the art.

The processor 705, in one embodiment, may include any known controller capable of executing computer-readable instructions and/or capable of performing logical operations. For example, the processor 705 may be a microcontroller, a microprocessor, a CPU, a GPU, an APU, a FPGA, or similar programmable controller. In some embodiments, the processor 705 executes instructions stored in the memory 710 to perform the methods and routines described herein. The processor 705 is communicatively coupled to the memory 710, the input device 715, the output device 720, and the transceiver 725.

In various embodiments, the NE apparatus 700 is a radio access entity (e.g., gNB) that communicates with one or more UEs and one or more NFs, as described herein. In such embodiments, the processor 705 controls the NE apparatus 700 to perform the above-described RAN behaviors. When operating as a radio access entity, the processor 705 may include an application processor (also known as “main processor”) which manages application-domain and operating system (“OS”) functions and a baseband processor (also known as “baseband radio processor”) which manages radio functions.

The memory 710, in one embodiment, is a computer readable storage medium. In some embodiments, the memory 710 includes volatile computer storage media. For example, the memory 710 may include a RAM, including dynamic RAM (“DRAM”), synchronous dynamic RAM (“SDRAM”), and/or static RAM (“SRAM”). In some embodiments, the memory 710 includes non-volatile computer storage media. For example, the memory 710 may include a hard disk drive, a flash memory, or any other suitable non-volatile computer storage device. In some embodiments, the memory 710 includes both volatile and non-volatile computer storage media.

In some embodiments, the memory 710 stores data related to determining a best beam for SL communication and/or mobile operation. For example, the memory 710 may store parameters, configurations, resource assignments, policies, and the like, as described above. In certain embodiments, the memory 710 also stores program code and related data, such as an operating system or other controller algorithms operating on the NE apparatus 700.

The input device 715, in one embodiment, may include any known computer input device including a touch panel, a button, a keyboard, a stylus, a microphone, or the like. In some embodiments, the input device 715 may be integrated with the output device 720, for example, as a touchscreen or similar touch-sensitive display. In some embodiments, the input device 715 includes a touchscreen such that text may be input using a virtual keyboard displayed on the touchscreen and/or by handwriting on the touchscreen. In some embodiments, the input device 715 includes two or more different devices, such as a keyboard and a touch panel.

The output device 720, in one embodiment, is designed to output visual, audible, and/or haptic signals. In some embodiments, the output device 720 includes an electronically controllable display or display device capable of outputting visual data to a user. For example, the output device 720 may include, but is not limited to, an LCD display, an LED display, an OLED display, a projector, or similar display device capable of outputting images, text, or the like to a user. As another, non-limiting, example, the output device 720 may include a wearable display separate from, but communicatively coupled to, the rest of the NE apparatus 700, such as a smart watch, smart glasses, a heads-up display, or the like. Further, the output device 720 may be a component of a smart phone, a personal digital assistant, a television, a table computer, a notebook (laptop) computer, a personal computer, a vehicle dashboard, or the like.

In certain embodiments, the output device 720 includes one or more speakers for producing sound. For example, the output device 720 may produce an audible alert or notification (e.g., a beep or chime). In some embodiments, the output device 720 includes one or more haptic devices for producing vibrations, motion, or other haptic feedback. In some embodiments, all or portions of the output device 720 may be integrated with the input device 715. For example, the input device 715 and output device 720 may form a touchscreen or similar touch-sensitive display. In other embodiments, the output device 720 may be located near the input device 715.

The transceiver 725 includes at least one transmitter 730 and at least one receiver 735. One or more transmitters 730 may be used to communicate with the UE 205, as described herein. Similarly, one or more receivers 735 may be used to communicate with network functions in the PLMN and/or RAN, as described herein. Although only one transmitter 730 and one receiver 735 are illustrated, the NE apparatus 700 may have any suitable number of transmitters 730 and receivers 735. Further, the transmitter(s) 730 and the receiver(s) 735 may be any suitable type of transmitters and receivers.

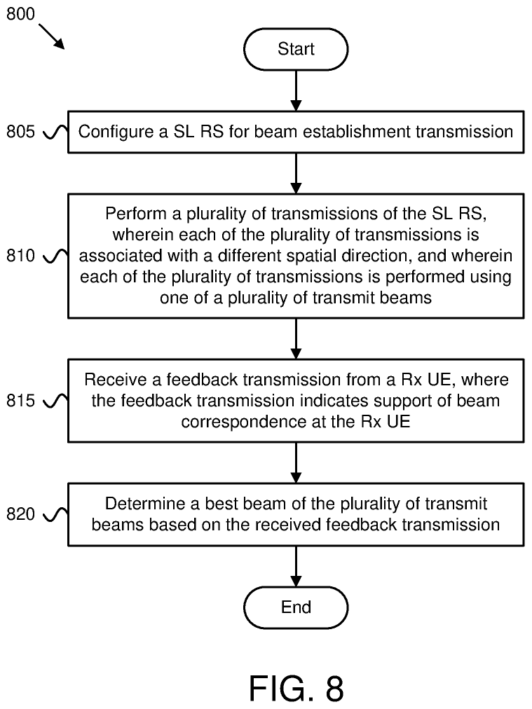

FIG. 8 illustrates a flowchart of a method 800 for determining a best beam for SL communication, in accordance with aspects of the present disclosure. The operations of the method 800 may be implemented by a receiving entity, such as the remote unit 105, the UE 205, the Tx UE 301, the Tx UE 405, and/or the UE apparatus 600 (or components thereof), as described herein. Additionally, or alternatively, the operations of the method 800 may be performed by a processor executing program code, for example, a microcontroller, a microprocessor, a CPU, a GPU, an APU, a FPGA, or the like.

The method 800 begins and configures 805 a SL RS for beam establishment transmission. The method 800 includes performing 810 a plurality of transmissions of the SL RS, where each SL RS transmission is associated with a different spatial direction, and where each SL RS transmission is performed using one of a plurality of transmit beams. The method 800 includes receiving 815 a feedback transmission from a Rx UE, where the feedback transmission indicates support of beam correspondence at the Rx UE. The method 800 includes determining 820 a best transmit beam of the plurality of transmit beams based on the received feedback transmission. The method 800 ends.

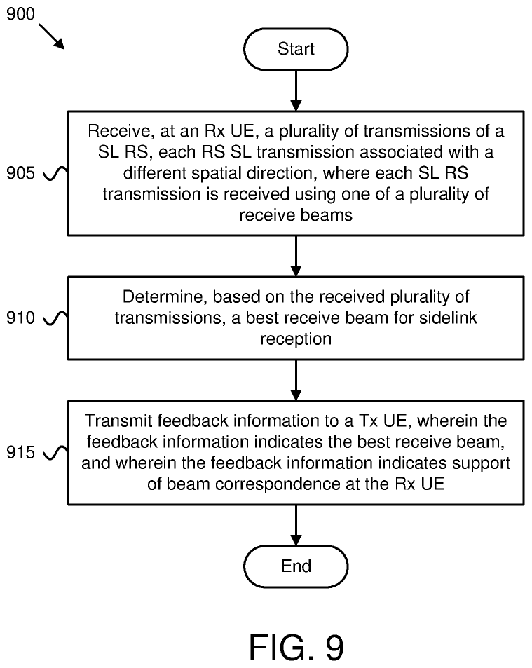

FIG. 9 illustrates a flowchart of a method 900 for determining a best beam for SL communication, in accordance with aspects of the present disclosure. The operations of the method 900 may be implemented by a receiving entity, such as the remote unit 105, the UE 205, the Rx UE 303, the Rx UE 410, and/or the UE apparatus 600 (or components thereof), as described herein. Additionally, or alternatively, the operations of the method 900 may be performed by a processor executing program code, for example, a microcontroller, a microprocessor, a CPU, a GPU, an APU, a FPGA, or the like.

The method 900 begins and receives 905, at an Rx UE, a plurality of transmissions of a SL RS, where each SL RS transmission is associated with a different spatial direction, and where each SL RS transmission is received using one of a plurality of beams. The method 900 includes determining 910, based on the received plurality of transmissions, a best receive beam for SL reception. The method 900 includes transmitting 915 feedback information to a Tx UE, where the feedback information indicates the best receive beam and indicates support of beam correspondence at the receiving UE device.

Disclosed herein is a first apparatus for determining a best beam for SL communication, in accordance with aspects of the present disclosure. The first apparatus may be implemented by a transmitting UE device, such as the remote unit 105, the UE 205, the Tx UE 301, the Tx UE 405, and/or the UE apparatus 600, described above. The first apparatus includes a processor coupled to a memory storing instructions executable by the processor to cause the first apparatus to: A) configure a SL RS for beam establishment transmission: B) perform a plurality of transmissions of the SL RS, where each SL RS transmission is associated with a different spatial direction, and where each SL RS transmission is performed using one of a plurality of transmit beams: C) receive a feedback transmission from a Rx UE, where the feedback transmission indicates support of beam correspondence at the Rx UE; and D) determine a best transmit beam of the plurality of transmit beams based on the received feedback transmission.

Note that while the first apparatus is described in terms of transmitting on “beams” and identifying a “best beam,” in other embodiments the SL RS may be transmitted via a plurality of antenna panels, where a “best antenna panel” is subsequently determined. As used herein, the term “beam/panel” (or similar notation) indicates that the description applies to a beam and/or UE panel.

In some embodiments, the instructions are executable by the processor to cause the apparatus to transmit the SL RS before or concurrent with a discovery procedure for SL unicast connection establishment (e.g., before DCR and DCA message exchange). In other embodiments, the instructions are executable by the processor to cause the apparatus to transmit the SL RS after or concurrent with a discovery procedure for SL unicast connection establishment (e.g., after DCR and DCA message exchange).

In some embodiments, the SL RS may include one or more of: a CSI-RS, a SL SSB, a Zadoff-Chu sequence, or a combination thereof. In certain embodiments, the CSI-RS is QCL'ed with a PSCCH transmission.

In some embodiments, the instructions are executable by the processor to cause the apparatus to transmit—with the SL RS—SCI, SL data (i.e., PSSCH), or a combination thereof. In certain embodiments, the SCI includes assistance information for aiding/assisting a discovery procedure for SL unicast connection establishment. In such embodiments, the assistance information may include one or more of: A) a default source ID, B) a default destination ID, C) a service type, D) an application ID, and/or E) QoS information. In certain embodiments, the SCI includes information related to beam/panel indices of the plurality of beams/panels.

In some embodiments, the received feedback transmission includes a second RS transmission. In some embodiments, the received feedback transmission includes a best received beam/panel ID (e.g., in terms of RSRP). In some embodiments, the processor further defines a default TCI table in a resource pool to indicate a QCL relationship for beam establishment.

In some embodiments, to perform the plurality of transmissions of the SL RS, the instructions are executable by the processor to cause the first apparatus to transmit each of the plurality of transmissions from one of a plurality of antenna panels in a different timeslot using a combination of different spatial direction and time domain repetition (i.e., beam sweeping). In certain embodiments, the number of time domain repetitions of the SL RS is less than or equal to the number of available beams/panels.

In certain embodiments, the number of time domain repetitions of the SL RS is greater than the number of available beams/panels. In such embodiments, the instructions are executable by the processor to cause the first apparatus to establish a QCL relationship between SL RS resources (e.g., CSI-RS resources) and to determine a QCL relationship between SL RS repetitions using a modulo operation.

Disclosed herein is a first method for determining a best beam for SL communication, in accordance with aspects of the present disclosure. The first method may be performed by a transmitting UE device, such as the remote unit 105, the UE 205, the Tx UE 301, the Tx UE 405, and/or the UE apparatus 600, described above. The first method includes configuring a SL RS for beam establishment transmission and performing a plurality of transmissions of the SL RS, where each SL RS transmission is associated with different spatial directions, and where each SL RS transmission is performed using one of a plurality of transmit beams. The first method includes receiving a feedback transmission from a Rx UE, where the feedback transmission indicates support of beam correspondence at the Rx UE, and determining a best transmit beam of the plurality of transmit beams based on the received feedback transmission.

Note that while the first method is described in terms of transmitting on “beams” and identifying a “best beam,” in other embodiments the SL RS may be transmitted via a plurality of antenna panels, where a “best antenna panel” is subsequently determined. As used herein, the term “beam/panel” (or similar notation) indicates that the description applies to a beam and/or antenna panel.

In some embodiments, transmitting the SL RS occurs before or concurrent with a discovery procedure for SL unicast connection establishment (e.g., before DCR and DCA message exchange). In other embodiments, transmitting the SL RS occurs after or concurrent with a discovery procedure for SL unicast connection establishment (e.g., after DCR and DCA message exchange).

In some embodiments, the SL RS may include one or more of: a CSI-RS, a SL SSB, a Zadoff-Chu sequence, or a combination thereof. In certain embodiments, the CSI-RS is QCL'ed with a PSCCH transmission.

In some embodiments, performing the plurality of transmissions of the SL RS includes transmitting the SL RS with SCI, SL data (i.e., PSSCH), or a combination thereof. In certain embodiments, the SCI includes assistance information for aiding/assisting a discovery procedure for SL unicast connection establishment. In such embodiments, the assistance information may include one or more of: A) a default source ID, B) a default destination ID, C) a service type, D) an application ID, and/or E) QoS information. In certain embodiments, the SCI includes information related to beam/panel indices of the plurality of beams/panels.

In some embodiments, the received feedback transmission includes a second RS transmission. In some embodiments, the received feedback transmission includes a best received beam/panel ID (e.g., in terms of RSRP). In some embodiments, the first method further includes defining a default TCI table in a resource pool to indicate a QCL relationship for beam establishment.

In some embodiments, performing the plurality of transmission of the SL RS includes transmitting each of the plurality of transmissions from one of a plurality of antenna panels in a different timeslot using a combination of different spatial direction and time domain repetition (i.e., beam sweeping). In certain embodiments, the number of time domain repetitions of the SL RS is less than or equal to the number of available beams/panels.

In certain embodiments, the number of time domain repetitions of the SL RS is greater than the number of available beams/panels. In such embodiments, the processor establishes a QCL relationship between SL RS resources (e.g., CSI-RS resources) and determining a QCL relationship between SL RS repetitions using a modulo operation.

Disclosed herein is a second apparatus for determining a best beam for SL communication, in accordance with aspects of the present disclosure. The second apparatus may be implemented by a receiving UE device, such as the remote unit 105, the UE 205, the Rx UE 303, the Rx UE 410, and/or the UE apparatus 600, described above. The second apparatus includes a processor coupled to a memory storing instructions executable by the processor to cause the second apparatus to: A) receive, from a Tx UE, a plurality of transmissions of a SL RS, where each SL RS transmission is associated with a different spatial direction, and where each SL RS transmission is received using one of a plurality of receive beams: B) determine, based on the received plurality of transmissions, a best receive beam for SL reception; and C) transmit feedback information to the Tx UE, where the feedback information indicates the best receive beam and indicates support of beam correspondence at the second apparatus.

Note that while the second apparatus is described in terms of receiving on “beams” and identifying a “best beam,” in other embodiments the SL RS may be received via a plurality of antenna panels, where a “best antenna panel” is subsequently determined. As used herein, the term “beam/panel” (or similar notation) indicates that the description applies to a beam and/or UE panel.

In some embodiments, the SL RS may include one or more of: a CSI-RS, a SL SSB, a Zadoff-Chu sequence, or a combination thereof. In certain embodiments, the CSI-RS is QCL'ed with a PSCCH transmission.

In some embodiments, the instructions are executable by the processor to cause the second apparatus to receive the SL RS with SCI, SL data (i.e., PSSCH), or a combination thereof. In certain embodiments, the SCI includes assistance information for aiding/assisting a discovery procedure for SL unicast connection establishment. In such embodiments, the assistance information may include one or more of: A) a default source ID, B) a default destination ID, C) a service type, D) an application ID, and/or E) QoS information. In certain embodiments, the SCI includes information related to beam/panel indices of the plurality of beams/panels.

In some embodiments, the transmitted feedback information includes a second RS transmission. In some embodiments, the transmitted feedback information includes a best received beam/panel ID (e.g., in terms of RSRP). In some embodiments, the instructions are executable by the processor to cause the second apparatus to receive a resource pool configuration that defines a default TCI table to indicate a QCL relationship for beam establishment.

In some embodiments, to receive the plurality of transmissions of the SL RS, the instructions are executable by the processor to cause the apparatus to receive each of the plurality of transmissions at one of a plurality of antenna panels in a different timeslot using a combination of different spatial direction and time domain repetition (i.e., beam sweeping). In certain embodiments, the number of time domain repetitions of the SL RS is less than or equal to the number of available beams/panels.

In certain embodiments, the number of time domain repetitions of the SL RS is greater than the number of available beams/panels. In such embodiments, the instructions are executable by the processor to cause the apparatus to receive a QCL relationship between SL RS resources (e.g., CSI-RS resources) and to determine a QCL relationship between SL RS repetitions using a modulo operation.

Disclosed herein is a second method for determining a best beam for SL communication, in accordance with aspects of the present disclosure. The second method may be performed by a receiving UE device, such as the remote unit 105, the UE 205, the Rx UE 303, the Rx UE 410, and/or the UE apparatus 600, described above. The second method includes receiving, from a Tx UE, a plurality of transmissions of a SL RS, where each SL RS transmission is associated with a different spatial direction, and where each SL RS transmission is received using one of a plurality of beams. The second method includes determining, based on the received plurality of transmissions, a best receive beam for SL reception and transmitting feedback information to the Tx UE, where the feedback information indicates the best receive beam and indicates support of beam correspondence at the receiving UE device.

Note that while the second method is described in terms of receiving on “beams” and identifying a “best beam,” in other embodiments the SL RS may be received via a plurality of antenna panels, where a “best antenna panel” is subsequently determined. As used herein, the term “beam/panel” (or similar notation) indicates that the description applies to a beam and/or UE panel.

In some embodiments, the SL RS may include one or more of: a CSI-RS, a SL SSB, a Zadoff-Chu sequence, or a combination thereof. In certain embodiments, the CSI-RS is QCL'ed with a PSCCH transmission.

In some embodiments, the second method may include receiving the SL RS with SCI, SL data (i.e., PSSCH), or a combination thereof. In certain embodiments, the SCI includes assistance information for aiding/assisting a discovery procedure for SL unicast connection establishment. In such embodiments, assistance information may include one or more of: A) a default source ID, B) a default destination ID, C) a service type, D) an application ID, and/or E) QoS information. In certain embodiments, the SCI includes information related to beam/panel indices of the plurality of beams/panels.

In some embodiments, the transmitted feedback information includes a second RS transmission. In some embodiments, the transmitted feedback information includes a best received beam/panel ID (e.g., in terms of RSRP). In some embodiments, the second method further includes receiving a resource pool configuration that defines a default TCI table to indicate a QCL relationship for beam establishment.

In some embodiments, receiving the plurality of transmissions of the SL RS includes receiving each of the plurality of transmissions at one of a plurality of antenna panels in a different timeslot using a combination of different spatial direction and time domain repetition (i.e., beam sweeping). In certain embodiments, the number of time domain repetitions of the SL RS is less than or equal to the number of available beams/panels.

In certain embodiments, the number of time domain repetitions of the SL RS is greater than the number of available beams/panels. In such embodiments, the second method further includes receiving a QCL relationship between SL RS resources (e.g., CSI-RS resources) and determining a QCL relationship between SL RS repetitions using a modulo operation.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects.

For example, the disclosed embodiments may be implemented as a hardware circuit comprising custom very-large-scale integration (“VLSI”) circuits or gate arrays, off-the-shelf semiconductors such as logic chips, transistors, or other discrete components. The disclosed embodiments may also be implemented in programmable hardware devices such as field programmable gate arrays, programmable array logic, programmable logic devices, or the like. As another example, the disclosed embodiments may include one or more physical or logical blocks of executable code which may, for instance, be organized as an object, procedure, or function.

Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a RAM, a read-only memory (“ROM”), an erasable programmable read-only memory (“EPROM”), an electronically erasable programmable read-only memory (“EEPROM”), a Flash memory, a portable compact disc read-only memory (“CD-ROM”), an optical storage device, a magnetic storage device, or any suitable combination of the foregoing. In the context of this document, a computer readable storage medium may be any tangible medium that can contain or store a program for use by or in connection with an instruction execution system, apparatus, or device.

Code for carrying out operations for embodiments may be any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”), WLAN, or a wide area network (“WAN”), or the connection may be made to an external computer (for example, through the Internet using an Internet Service Provider (“ISP”)).

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including.” “comprising.” “having.” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “at least one of A, B and C” includes only A, only B, only C, a combination of A and B, a combination of B and C, a combination of A and C or a combination of A, B and C. As used herein, “a member selected from the group consisting of A, B, and C,” includes one and only one of A, B, or C, and excludes combinations of A, B, and C. As used herein, “a member selected from the group consisting of A, B, and C and combinations thereof” includes only A, only B, only C, a combination of A and B, a combination of B and C, a combination of A and C or a combination of A, B and C.

Aspects of the embodiments are described above with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart diagrams and/or block diagrams.

The code may also be stored in a storage device that can direct a computer, other programmable data processing apparatus, or other devices to function in a particular manner, such that the instructions stored in the storage device produce an article of manufacture including instructions which implement the function/act specified in the flowchart diagrams and/or block diagrams.

The code may also be loaded onto a computer, other programmable data processing apparatus, or other devices to cause a series of operational steps to be performed on the computer, other programmable apparatus, or other devices to produce a computer implemented process such that the code which execute on the computer or other programmable apparatus provide processes for implementing the functions/acts specified in the flowchart diagrams and/or block diagrams.

The call-flow diagrams, flowchart diagrams and/or block diagrams in the Figures illustrate the architecture, functionality, and operation of possible implementations of apparatuses, systems, methods, and program products according to various embodiments. In this regard, each block in the flowchart diagrams and/or block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the call-flow, flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

1. An apparatus comprising:
a processor; and
a memory coupled to the processor, the memory comprising instructions executable by the processor to cause the apparatus to:
configure a sidelink reference signal (“SL RS”) for beam establishment transmission;
perform a plurality of transmissions of the SL RS, wherein each of the plurality of transmissions is associated with a different spatial direction, and wherein each of the plurality of transmissions is performed using one of a plurality of transmit beams;
receive a feedback transmission from a receiver User Equipment (“UE”), wherein the feedback transmission indicates support of beam correspondence at the receiver UE; and
determine a best transmit beam of the plurality of transmit beams based on the received feedback transmission.

2. The apparatus of claim 1, wherein the instructions are executable by the processor to cause the apparatus to perform the plurality of transmissions of the SL RS before or concurrent with a discovery procedure for sidelink unicast connection establishment.

3. The apparatus of claim 1, wherein the instructions are executable by the processor to cause the apparatus to perform the plurality of transmissions of the SL RS after or concurrent with a discovery procedure for sidelink unicast connection establishment.

4. The apparatus of claim 1, wherein the SL RS comprises one or more of: a Channel State Information Reference Signal (“CSI-RS”), a sidelink Synchronization Signal Block (“SL-SSB”), a Zadoff-Chu sequence, or a combination thereof.

5. The apparatus of claim 4, wherein the CSI-RS is Quasi-co-located with a Physical Sidelink Control Channel (“PSCCH”) transmission.

6. The apparatus of claim 1, wherein the instructions are executable by the processor to cause the apparatus to transmit Sidelink Control Information (“SCI”), data, or a combination thereof, with the SL RS.

7. The apparatus of claim 6, wherein the SCI comprises assistance information for aiding a discovery procedure for sidelink unicast connection establishment, wherein the assistance information comprises one or more of: a default source identity (“ID”), a default destination ID, a service type, an application ID, Quality of Service (“QoS”) information, or a combination thereof.

8. The apparatus of claim 6, wherein the SCI comprises information related to beam indices of the plurality of beams.

9. The apparatus of claim 1, wherein the received feedback transmission comprises one or more of: a second reference signal transmission, and a best received beam identity (“ID”), or a combination thereof.

10. The apparatus of claim 1, wherein to perform the plurality of transmissions of the SL RS, the instructions are executable by the processor to cause the apparatus to transmit each of the plurality of transmissions from one of a plurality of antenna panels in a different timeslot using a combination of different spatial direction and time domain repetition.

11. The apparatus of claim 10, wherein a number of time domain repetitions of the SL RS is less than or equal to a number of available beams/panels.

12. The apparatus of claim 10, wherein a number of time domain repetitions of the SL RS is greater than a number of available beams/panels, wherein the processor further establishes a Quasi-co-location (“QCL”) relationship between SL RS resources and determines a QCL relationship between SL RS repetitions using a modulo operation.

13. The apparatus of claim 1, wherein the processor further defines a default Transmission Configuration Indicator (“TCI”) table in a resource pool to indicate a Quasi-co-location (“QCL”) relationship for beam establishment.

14. A method at a transmitter User Equipment (“Tx UE”) for establishing a unicast beam, the method comprising:
configuring a sidelink reference signal (“SL RS”) for beam establishment transmission:
performing a plurality of transmissions of the SL RS, wherein each of the plurality of transmissions is associated with a different spatial direction, and wherein each of the plurality of transmissions is performed using one of a plurality of transmit beams;
receiving a feedback transmission from a receiver User Equipment (“UE”), wherein the feedback transmission indicates support of beam correspondence at the receiver UE; and
determining a best transmit beam of the plurality of transmit beams based on the received feedback transmission.

15. An apparatus comprising:
a processor; and
a memory coupled to the processor, the memory comprising instructions executable by the processor to cause the apparatus to:
receive, from a transmitter User Equipment (“UE”), a plurality of transmissions of a sidelink reference signal (“SL RS”), wherein each of the plurality of transmissions is associated with a different spatial direction, and wherein each of the plurality of transmissions is performed using one of a plurality of receive beams;
determine, based on the received plurality of transmissions, a best receive beam for sidelink reception; and
transmit feedback information to the transmitter UE, wherein the feedback information indicates the best receive beam, and wherein the feedback information indicates support of beam correspondence at the apparatus.
